(19) United States
(12) Patent Application Publication
(10) Pub. No.: US 2019/0388923 A1
(43) Pub. Date: Dec. 26, 2019

(54) BATTERY POWERED PRESSURE WASHER

(71) Applicant: BRIGGS & STRATTON CORPORATION, Wauwatosa, WI (US)

(72) Inventors: Joseph Giacalone, Hartland, WI (US); Tyler D. Masters, Wauwatosa, WI (US); Numan Jan, Wauwatosa, WI (US)

(73) Assignee: BRIGGS & STRATTON CORPORATION, Wauwatosa, WI (US)

(21) Appl. No.: 16/481,188

(22) PCT Filed: Jan. 26, 2018
(86) PCT No.: PCT/US2018/015487

§ 371 Date: Jul. 26, 2019

Related U.S. Application Data
(60) Provisional application No. 62/451,524, filed on Jan. 27, 2017.
(60) Provisional application No. 62/531,237, filed on Jul. 11, 2017.

(51) Int. Cl. B05B 12/00; B05B 1/02; B05B 1/30; B05B 12/08; B05B 7/12; B05B 9/01

(52) U.S. Cl. CPC B05B 12/002; B05B 1/02; B05B 1/30; B08B 2203/0223; B05B 7/12; B05B 9/01; B05B 12/08

(57) ABSTRACT

A pressure washer includes a water pump, a spray gun fluidly coupled to an outlet of the water pump, an electric motor coupled to the water pump to drive the water pump, a battery module configured to provide battery electricity, an electrical plug configured to receive grid electricity from a power outlet, and a power management system electrically connected to the battery module, the electrical plug, and the electric motor. The power management system is configured to selectively provide battery electricity from the battery module and grid electricity from the electrical plug to the electric motor to drive the water pump.

### CROSS-REFERENCE TO RELATED PATENT APPLICATIONS

This application claims the benefit of U.S. Provisional Patent Application No. 62/531,237, filed on Jul. 11, 2017, and U.S. Provisional Patent Application No. 62/451,524, filed on Jan. 27, 2017, both of which are incorporated herein by reference in their entireties.

### BACKGROUND

The present invention relates generally to the field of pressure washers, and in particular, to the field of battery powered pressure washers.

### SUMMARY

One embodiment of the invention relates to a pressure washer including a water pump, a spray gun fluidly coupled to an outlet of the water pump, an electric motor coupled to the water pump to drive the water pump, a battery module configured to provide battery electricity, an electrical plug configured to receive grid electricity from a power outlet, and a power management system. The power management system is electrically connected to the battery module, the electrical plug, and the electric motor. The power management system is configured to selectively provide battery electricity from the battery module and grid electricity from the electrical plug to the electric motor to drive the water pump. In some embodiments, the battery electricity current is at least 20 A. In some embodiments, a user interface of the pressure washer includes a battery charge indicator displaying at least one of a charge of the battery module and an estimated remaining run time. In some embodiments, the pressure washer further includes a base unit configured to support the water pump, the electric motor, and the battery module, where the user interface is a component of the base unit. In some embodiments, the user interface is a component of the spray gun. In some embodiments, the user interface is coupled to the spray gun. In some embodiments, the electrical plug is a component of the base unit and is a male plug. In some embodiments, the spray gun includes a trigger configured to control a flow rate of water through the spray gun. In some embodiments, the pressure washer further includes a base unit configured to support the water pump, the electric motor, and the battery module, wherein the user interface is coupled to the base unit. In some embodiments, the pressure washer further includes an unloading sensor, wherein the unloading sensor is a pressure sensor and the power management system is configured to stop the electric motor in response to a pressure sensed by the unloading sensor exceeding a threshold level. In some embodiments, the pressure washer further includes an unloading sensor, wherein the unloading sensor is a flow sensor and the power management system is configured to stop the electric motor in response to a flow rate sensed by the unloading sensor falling below a threshold level. In some embodiments, the water pump further includes an unloading flow path fluidly coupling the outlet of the water pump to an inlet of the water pump. In some embodiments, the water pump does not include an unloading flow path fluidly coupling the outlet of the water pump to an inlet of the water pump. In some embodiments, the power management system includes a power converter, where the electric motor is a direct current motor, and where the power converter converts alternating current from the electrical plug to direct current applied to the electric motor. In some embodiments, the power management system includes a power inverter where the electric motor is an alternating current motor and the power inverter converts direct current from the battery module to alternating current applied to the electric motor. In some embodiments, the electric motor is a universal motor.

Another embodiment of the invention relates to a backpack pressure washer including a water pump, an electric motor coupled to the water pump to drive the water pump, a spray gun fluidly coupled to an outlet of the water pump, a battery module configured to selectively provide battery electricity to the electric motor, and a backpack supporting the water pump, the electric motor, and the battery module. The backpack is configured to support a portion of a weight of the backpack pressure washer on at least one shoulder of a user. In some embodiments, the water pump is a self-priming water pump.

Another embodiment of the invention relates to a pressure washer including a water pump, an electric motor coupled to the water pump to drive the water pump, at least two battery modules configured to provide battery electricity, and a power management system electrically connected to the at least two battery modules and configured to selectively provide battery electricity from the battery modules to the electric motor.

Another embodiment of the invention relates to a handheld pressure washer including a water pump, an electric motor coupled to the water pump to drive the water pump, a nozzle fluidly coupled to an outlet of the water pump, a battery module configured to provide battery electricity to the electric motor, and a spray gun unit, wherein the water pump, the electric motor, and the nozzle, are components of the spray gun unit. In some embodiments, the handheld pressure washer further includes a receptacle configured to receive battery electricity from the battery module, wherein the receptacle provides battery electricity to the electric motor, where the receptacle receives the battery module, and where the battery module is removable from the receptacle without the use of tools.

Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, in which:

FIG. 1A is a schematic view of a pressure washer, according to an exemplary embodiment.

FIG. 1B is a schematic view of a pressure washer, according to an exemplary embodiment.

FIG. 2 is a schematic view of the user interface of the pressure washers of FIGS. 1 and 2.

FIG. 3 is a schematic view of a floor-standing pressure washer, according to an exemplary embodiment.

FIG. 4 is a schematic view of a backpack pressure washer, according to an exemplary embodiment.

FIG. 5 is a schematic view of a handheld pressure washer, according to an exemplary embodiment.

### DETAILED DESCRIPTION

Before turning to the figures, which illustrate the exemplary embodiments in detail, it should be understood that the application is not limited to the details or methodology set forth in the description or illustrated in the figures. It should also be understood that the terminology is for the purpose of description only and should not be regarded as limiting.

A pressure washer provides a pressurized spray of water. The pressure washer includes a water pump driven by an electric motor powered at least in part by one or more battery modules. A power management system varies the flow of battery electricity from one or more battery modules to the electric motor to vary the characteristics of the pressurized spray. The power management system may connect two or more battery modules in series or parallel in order to extend the battery life of the pressure washer or the maximum rated pressure of the pressurized spray. In some embodiments, the power management system further receives grid electricity from a power outlet and selectively provides the electric motor with one or both of the grid electricity and the battery electricity. This provides a user with the option to maneuver the pressure washer without being connected to the power outlet or to connect to the standard power outlet to run for an extended period of time. Additionally, power can be drawn from both the battery modules and the power outlet to increase the maximum rated pressure of the pressurized spray. In some embodiments, the pressure washer includes a base unit that supports the battery modules, the pump, and the electric motor on wheels or a backpack connected to a spray gun by a high-pressure hose. In other embodiments, the high-pressure hose is omitted and the water pump, the electric motor, the battery modules, and a nozzle are incorporated into a single spray gun unit.

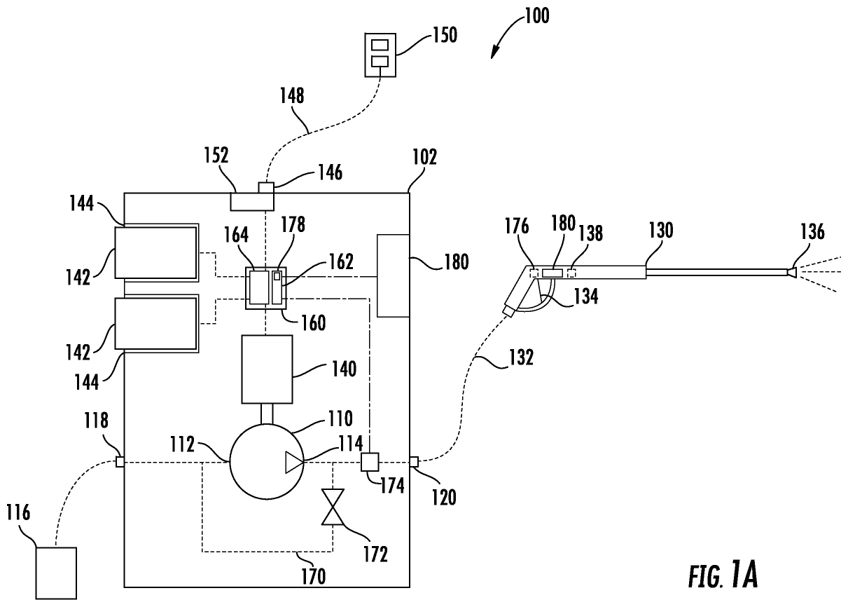

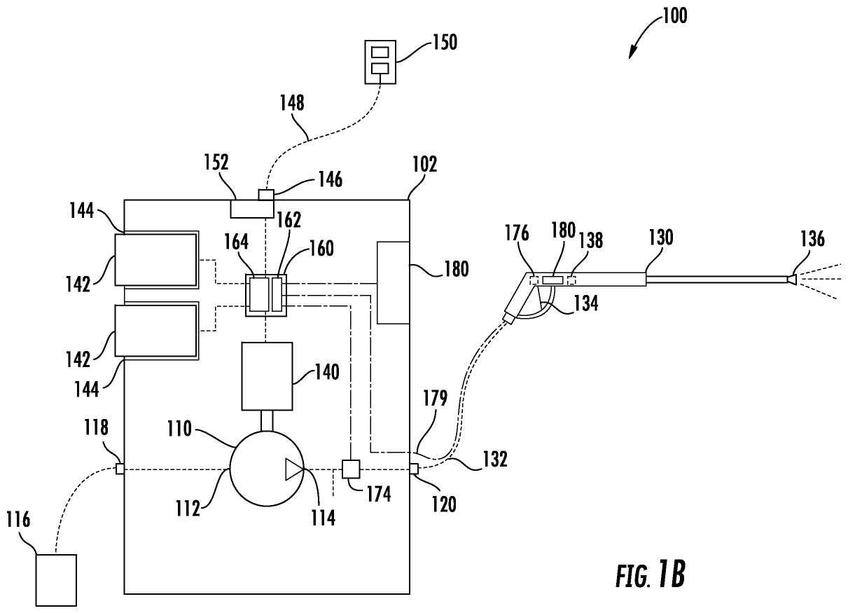

Referring to FIGS. 1A and 1B, a pressure washer 100 is shown according to exemplary embodiments. The pressure washer 100 includes a support structure 102. The support structure 102 supports and houses the other components of the pressure washer 100. In some embodiments, the support structure 102 is sealed (i.e., waterproof) to prevent water from entering the support structure 102 and damaging any of the other components inside. In some embodiments, the individual components are waterproof. In some embodiments, the support structure may include one or both of an open frame (in the manner of many conventional gas powered pressure washers) and a housing. By way of example, the support structure 102 may include a number of structural tubular frame members with a plastic housing that extends between the frame members. The support structure 102 may incorporate a device for facilitating transportation of the pressure washer 100 (e.g., handles, straps, wheels, slides, etc.). The support structure 102 may incorporate devices for storing other objects in or attaching other objects to the pressure washer 100 (e.g., pockets, clips, shelves, etc.). In some embodiments, the support structure 102 is included in a base unit that is separated from a spray gun by a high-pressure hose (discussed below) and supports a number of pumping and electrical components. In other embodiments, all of the pumping, electrical, and spraying components of the pressure washer 100 are components of a spray gun unit (discussed below).

Referring again to FIGS. 1A and 1B, the pressure washer 100 further includes a water pump 110. The water pump 110 may be any variety of pumps capable of pumping a liquid (e.g., a centrifugal pump, a positive displacement pump, etc.). The water pump 110 draws in low-pressure water at the inlet 112 of the water pump 110, and expels pressurized (i.e., high-pressure) water at the outlet 114 of the water pump 110. The inlet 112 is fluidly coupled to a low-pressure water source 116. In the embodiments shown in FIGS. 1A and 1B, the low-pressure water source 116 is a municipal water source. In other embodiments, the low-pressure water source 116 may be a source configured to contain a volume of liquid (e.g., a rain barrel, a bucket, an on-board reservoir, etc.). In some such embodiments, the water pump 110 is a self-priming pump to facilitate drawing water from a source with little or no head pressure. In other embodiments, the water pump 110 is not self-priming. The pressure washer 100 may include an inlet fitting 118 (e.g., a garden hose fitting, a quick disconnect fitting, etc.) coupled to the support structure 102 to facilitate connection to the low-pressure water source 116 (e.g., using a garden or other low-pressure hose). In some embodiments, the outlet 114 of the water pump 110 is fluidly coupled to an outlet fitting 120 (i.e., a quick disconnect fitting) coupled to the support structure 102.

As shown in FIGS. 1A and 1B, the outlet fitting 120 is fluidly coupled to a spray gun 130 by means of a high-pressure hose 132. The high-pressure hose 132 may include corresponding fittings (e.g., quick-disconnect fittings) on one or both ends to fluidly couple to the outlet fitting 120 and the spray gun 130. The spray gun 130 includes a trigger 134 configured to control a flow rate of water through the spray gun 130 and a nozzle 136. In some embodiments, the trigger 134 is biased into a neutral position by a biasing force (e.g., from a spring or other biasing member). The spray gun 130 is fluidly coupled to the outlet 114 of the water pump 110 such that the nozzle 136 is also fluidly coupled to the outlet 114. The nozzle 136 is positioned to act as an outlet to the spray gun 130 (i.e. a spray gun outlet). In some embodiments, the nozzle 136 may be interchangeable with other nozzles having differing spray patterns and/or pressure. In other embodiments, the nozzle 136 is a turret that can be rotated to select between a number of different nozzles. In some embodiments, the spray gun 130 further includes a valve 138 disposed along a flow path between the outlet 114 and the nozzle 136. The valve 138 is configured to variably restrict the flow along the flow path based upon the position of the trigger 134. By way of example, when the trigger 134 is in the neutral position, the valve 138 may completely prevent flow along the flow path. By way of another example, the valve 138 may open (i.e., lessen the restriction on the flow) as the trigger 134 moves farther from the neutral position.

Referring again to FIGS. 1A and 1B, an electric motor 140 drives the water pump 110. Electric motor 140 may be an alternating current (AC) motor, a direct current (DC) motor, or a universal motor (i.e., a motor that accepts both AC power and DC power). Battery electricity is provided to the pressure washer 100 by one or more battery modules 142. The battery modules 142 may include various numbers and types (lithium-ion, lead acid, etc.) of battery cells in various configurations (e.g., some cells connected in series and some cells connected in parallel) to achieve the desired battery characteristics (e.g., amp-hour rating, voltage, weight, etc.). In some embodiments, the one or more battery modules 142 are contained within and/or coupled to the support structure 102. In other embodiments, the one or more battery modules 142 are each received by a receptacle 144. Receptacles 144 support the battery modules 142 and are electrically connected to the battery modules 142. In some embodiments, the receptacles 144 are configured to facilitate removal of the battery modules 142 without the use of tools. By way of example, the receptacles 144 may include springs to bias the battery modules 142 out of the receptacles 144 and latches to selectively hold the battery modules 142 in the receptacles 144. In some embodiments, the battery modules 142 are hot swappable (i.e., one or more of the battery modules 142 may be removed or replaced while the pressure washer 100 is in operation). The receptacles 144 may include seals to waterproof the connections between the receptacles 144 and the battery modules 142.

The battery modules 142 can be used in other portable power equipment as well (e.g., string trimmers, leaf blowers, small chainsaws, vacuums, lights, radios, etc.). Employing the same battery modules 142 in other equipment provides the end user with additional utility from the power source of the pressure washer 100 when it would otherwise be off and inactive. The pressure washer 100, one or more battery modules 142, a charger, and one or more additional pieces of power equipment powerable by the battery modules 142 can be sold in a bundle or package. By way of example, the additional pieces of power equipment may include lawn mowers, chain saws, leaf blowers, and string trimmers.

In some embodiments, as shown in FIGS. 1A and 1B, the pressure washer 100 receives grid electricity through an electrical plug 146. In some embodiments, the electrical plug 146 is a male plug attached to the end of a short electrical cord attached to the base unit or is a male plug that is a component of the base unit, and the electrical plug 146 interfaces with an electrical extension cord 148. The electrical extension cord 148 interfaces with a standard power outlet 150 and grid electricity runs though the electrical extension cord 148, through the electrical plug 146, and into the pressure washer 100. In other embodiments, the electrical plug 146 is electrically coupled to the pressure washer 100 though an electrical cord attached to the base unit, and the electrical plug 146 interfaces directly with the standard power outlet 150 to receive grid electricity. The pressure washer 100 further includes a Ground Fault Circuit Interrupter unit (GFCI) 152 that disconnects the electrical connection to grid electricity upon detection of a ground fault. In some embodiments, the GFCI 152 is a component of and/or is located partially within the base unit or spray gun unit. In other embodiments, the GFCI 152 is located along the length of the electrical cord or is incorporated into the electrical plug 146. The GFCI 152 may include an externally accessible means (e.g., a button, a switch, etc.) of resetting the GFCI 152 (i.e., restoring the electrical connection to grid electricity).

The electric motor 140 is electrically connected to and receives electrical power from a power management system 160. In embodiments that include the one or more battery modules 142, the power management system 160 is electrically connected to the battery modules 142 and/or the receptacles 144 and receives battery electricity from the battery modules 142. In embodiments that include the electrical plug 146, the power management system 160 is electrically connected to one or both of the electrical plug 146 and the GFCI 152 and receives grid electricity from the standard power outlet 150. The power management system 160 selectively provides battery electricity from the battery modules 142 and grid electricity from the electrical plug 146 to the electric motor 140 to drive the water pump 110.

In some embodiments, the power management system 160 includes a controller or processing circuit 162. A controller 162 can include a processor and memory device. The processor can be implemented as a general-purpose processor, an application specific integrated circuit (ASIC), one or more field programmable gate arrays (FPGAs), a group of processing components, or other suitable electronic processing components. The memory device (e.g., memory, memory unit, storage device, etc.) is one or more devices (e.g., RAM, ROM, Flash memory, hard disk storage, etc.) for storing data and/or computer code for completing or facilitating the various processes, layers and modules described in the present application. The memory device may be or include volatile memory or non-volatile memory. The memory device may include database components, object code components, script components, or any other type of information structure for supporting the various activities and information structures described in the present application. According to an exemplary embodiment, the memory device is communicably connected to the processor via a processing circuit and includes computer code for executing (e.g., by processing circuit and/or processor) one or more processes described herein. The controller 162 is used to control the flow of electricity based on a number of factors described herein. In other embodiments, the power management system 160 includes circuits with components manually operated by the user (e.g., switches) and/or sensors responsive to various operating conditions to control the flow of electricity without the use of a controller. In some embodiments, the power management system 160 includes both the controller 162 and one or more additional circuits.

Referring now to FIG. 7, a block diagram 600 of the controller 162 (e.g., proportional-integral-derivative (PID) controller 606) is shown. The controller 162 adjusts a control variable of the pressure washer 100 using proportional, integral, and derivative terms in a control loop feedback mechanism. As such, the controller 162 provides real-time responsive correction to the control function of the system 160. The controller 162 continuously calculates an error value 610 indicating the difference between a set value 602 and a measured actual value 608. The error value 610 is fed back into a calculation of the sum of error values over time. The controller 162 continues to perform this control feedback mechanism and produce outputs 612 to the system. In other embodiments, other feedback control schemes can be used. For example, the controller 162 can include a proportional-integral (PI) controller.

Referring back to FIGS. 1A and 1B, in some embodiments, the power management system 160 includes a power inverter or power converter 164. In embodiments where the electric motor 140 is a DC motor, the power management system 160 includes a power converter 164 that converts alternating current from the electrical plug 146 to direct current, which can then be selectively applied to the electric motor 140, and may be passed through the battery modules 142 before reaching the electric motor 140. In embodiments where the electric motor 140 is an AC motor, the power management system 160 includes a power inverter 164 that converts direct current from the battery modules 142 to alternating current, which can then be selectively applied to the electric motor 140. In some embodiments where the electric motor 140 is a universal motor, the conversion from AC to DC or DC to AC is not necessary, and the power inverter or power converter 164 are omitted.

In some embodiments, the pressure washer 100 further includes an unloading or recirculating flow path 170, shown in FIG. 1A. The unloading flow path 170 is fluidly coupled to the inlet 112 and the outlet 114 of the water pump 110. An unloading valve 172 is disposed along the unloading flow path 170, allows flow from the outlet 114 to the inlet 112 when open, and prevents flow from the outlet 114 to the inlet 112 when closed. The unloading valve 172 allows the electric motor 140 to continue running when the pressure washer 100 is not spraying (e.g., when the valve 138 is preventing flow to the nozzle 136). In some embodiments, the unloading valve 172 is pressure-activated and opens when the pressure at the outlet 114 exceeds a threshold pressure. In other embodiments, the unloading valve 172 is flow-activated and opens when the flow to the nozzle 136 falls below a threshold level. In some embodiments, the unloading valve 172 is mechanical and is not connected to the power management system 160. In FIG. 1A, the unloading valve 172 is shown disposed along the unloading flow path 170 beyond the point where the unloading flow path 170 separates from the flow to the nozzle 136. In other embodiments, the unloading valve 172 may be located elsewhere along the unloading flow path 170 (e.g., at the point where the unloading flow path 170 separates from the flow to the nozzle 136).

In some embodiments, as shown in FIGS. 1A and 1B, the pressure washer 100 further includes an unloading sensor 174. The unloading sensor 174 is disposed along the path of flow between the outlet 114 and the nozzle 136. The unloading sensor 174 is operatively coupled to the controller 162. In some embodiments, the unloading sensor 174 is a pressure sensor and provides a signal indicating the pressure of the fluid near the outlet 114. In other embodiments, the unloading sensor 174 is a flow sensor and provides a signal indicating the flow rate of fluid to the nozzle 136. The controller 162 is configured to slow the speed of or stop the electric motor 140 in response to this signal. By way of example, the controller 162 may be configured to stop the electric motor 140 in response to a signal from the unloading sensor 174 indicating that the pressure of the fluid near the outlet 114 has exceeded a threshold level. By way of another example, the controller 162 may be configured to stop the electric motor 140 in response to a signal from the unloading sensor 174 indicating that the flow rate of fluid to the nozzle 136 has fallen below a threshold level. In the exemplary embodiment shown in FIG. 1B, the unloading flow path 170 and the unloading valve 172 are omitted. The unloading sensor 174 is used to detect when there is a reduced demand for pressurized water (e.g., when the flow to the nozzle 136 drops below a threshold level), and the controller 162 reduces the speed of the motor 140 in response to the reduced demand, which allows for the omission of the unloading flow path 170 and unloading valve 172. Omitting the unloading flow path 170 and unloading valve 172 reduces the cost associated with manufacturing the pressure washer 100.

In some embodiments, the pressure washer 100 includes a trigger sensor 176 configured to sense the position of the trigger 134. The trigger sensor 176 is operatively coupled to the controller 162. In some embodiments that include a base unit, the spray gun 130 includes an electrical power source (e.g., a battery) that powers the trigger sensor 176. The trigger sensor 176 communicates with the controller 162 wirelessly using radio frequency transceiver 178, shown in FIG. 1A. Radio frequency transceiver 178 is a component of the base unit and is operatively coupled to the power management system 160. In some embodiments, the radio frequency transceiver is incorporated into the controller 162. In other embodiments that include a base unit, the trigger sensor 176 communicates with the controller 162 over a wired connection 179, shown in FIG. 1B. The wired connection 179 may run along the outside of the high-pressure hose 132. In some embodiments where a water pump and an electric motor are components of a spray gun unit, a wire passes from the trigger sensor 176 to the controller 162 through the support structure 102 to facilitate communication. In some embodiments, the power management system 160 controls the speed of the electric motor 140 in response to the position of the trigger 134 sensed by the trigger sensor 176, thereby varying the water pressure of the spray provided by the pressure washer 100 (i.e., the spray out of the nozzle 136). By way of example, the power management system 160 may stop the electric motor 140 in response to an indication from the trigger sensor 176 that the trigger 134 is in the neutral position. By way of another example, the trigger 134 may have a fully open position opposite the neutral position. The power management system 160 may vary the speed of the electric motor 140 proportionally to the position of the trigger 134 relative to the neutral and fully open positions. For example, the power management system 160 may run the electric motor 140 at 75 percent of the maximum speed when the trigger 134 is 75 percent of the way to the fully open position. In some embodiments, the pressure washer 100 includes the trigger sensor 176 in addition to the valve 138, and the trigger 134 actuates the valve 138 based on the current position of the trigger 134.

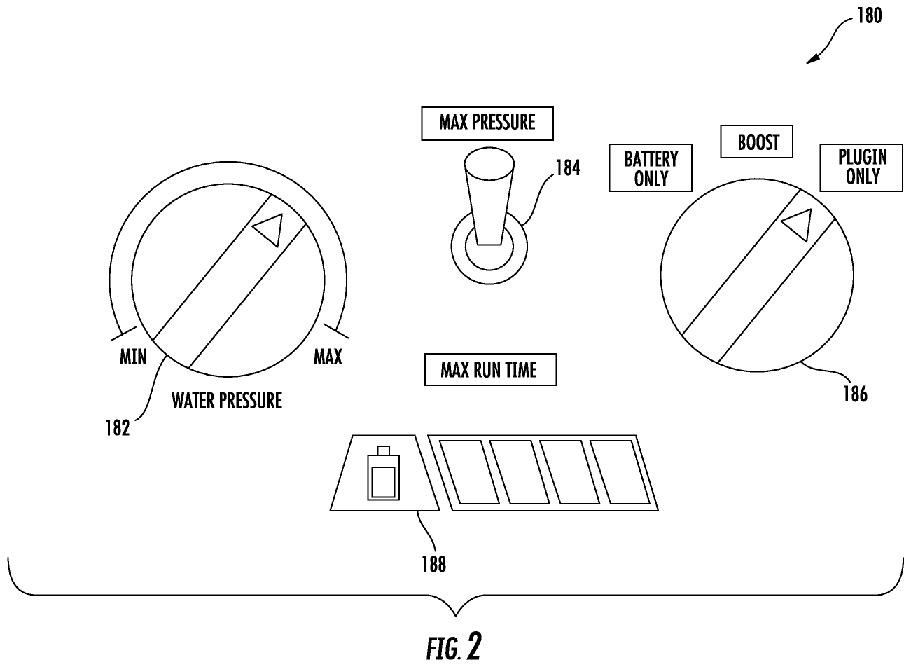

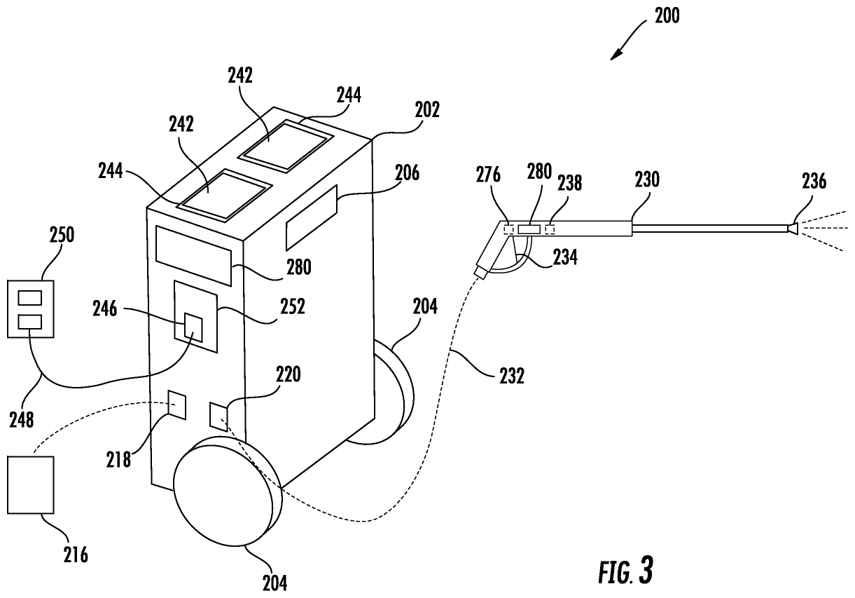

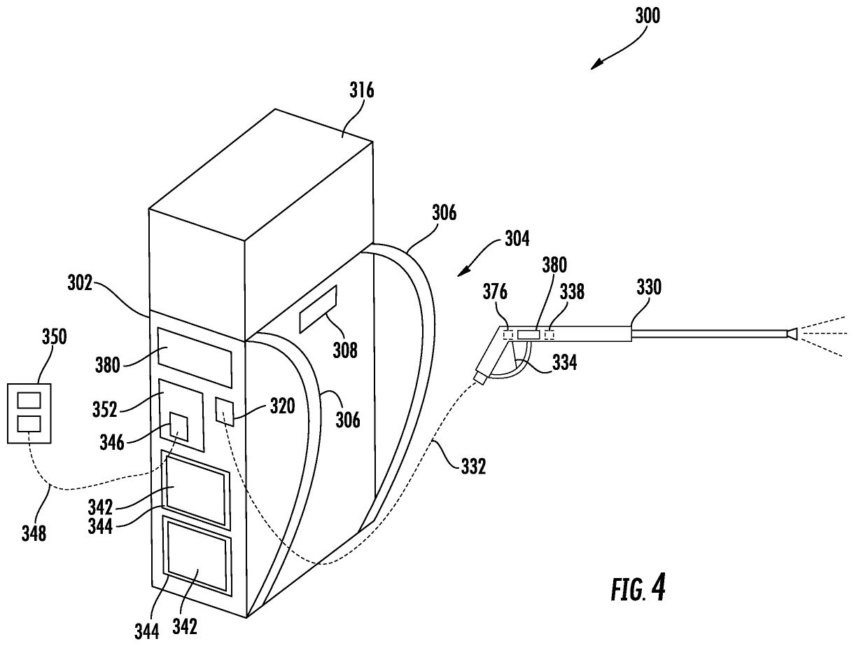

In some embodiments, the pressure washer 100 includes one or more user interfaces 180 configured to receive user inputs and/or display information to the user. The user interface 180 may be located on the spray gun 130, on the base unit (e.g., on the support structure 102 as shown in FIGS. 1A and 1B), or on the spray gun unit (e.g., on a support structure). As shown in FIG. 2, the user interface 180 includes one or more of a water pressure adjuster 182, an operating mode selector 184, a power source selector 186, and a battery charge indicator 188. In some embodiments, one or more of the water pressure adjuster 182, the operating mode selector 184, the power source selector 186, and the battery charge indicator 188 are present on the user interface 180 on the support structure 102, while some are present on the user interface 180 on the spray gun 130. In other embodiments, the user interface 180 includes other input devices or indicators (e.g., a power switch). In some embodiments, one or more of the user interfaces 180 are present on the base unit. In some embodiments, one or more of the user interfaces 180 are present on a spray gun (e.g., the spray gun 130). In some embodiments, one or more of the user interfaces 180 are present on the base unit and one or more user interfaces 180 are present on a spray gun.

The water pressure adjuster 182 is operatively coupled to the controller 162. The water pressure adjuster 182 may be any input device capable selecting between a range of values (e.g., a dial, an increase button and a decrease button, a slider, etc.). The power management system 160 is configured to vary the speed of the electric motor 140 in response to a signal from the water pressure adjuster 182. Varying the speed of the electric motor 140 varies the water pressure output of the spray from the spray gun 130. The power management system 160 may vary the speed of the electric motor 140 proportionally to the position of the water pressure adjuster 182. For example, the power management system 160 may run the electric motor 140 at 75 percent of the maximum speed when the water pressure adjuster 182 is 75 percent of the way to a maximum speed position. By way of another example, the power management system 160 may stop the electric motor 140 in response to an indication that the water pressure adjuster 182 is in a minimum speed position. Embodiments with this functionality may omit a power switch.

The operating mode selector 184 is present in some embodiments that include multiple battery modules 142. The operating mode selector 184 is operatively coupled to the controller 162. The operating mode selector 184 may be any input device capable of switching between a number of different configurations (e.g., a switch, a push button, a knob, etc.). The power management system 160 is configured to connect the battery modules 142 in either a maximum power configuration or a maximum run time configuration based on an input from the operating mode selector 184. In the maximum power configuration, the battery modules 142 are connected in parallel, allowing the current from each battery module 142 to combine and increase the net current applied to the electric motor 140. This increases the power output of the electric motor 140 for a given voltage, thereby increasing the water pressure of the spray provided by the pressure washer 100. In the maximum run time configuration, the battery modules 142 are connected in series, such that the same current flows through each battery module 142. This maintains the same power output of the electric motor 140 for a given voltage as if there were only one battery module 142, maintaining the same water pressure of the spray provided by the pressure washer 100 but increasing the run time before the charge of the battery modules 142 is depleted. An example graph 800 showing runtime plotted against boost pressure is shown in FIG. 9. As shown by line 802, as the boost pressure increases, the runtime capability decreases. For example, at approximately 250 pounds per square inch (psi), the runtime can range up to longer than 45 minutes, but at approximately 2300 psi, the runtime drops below five minutes. As shown by line 804, the boost pressure capability of the pressure washer 100 is in some cases limited to a maximum boost pressure (e.g., approximately 2300 psi).

The power source selector 186 is present in some embodiments that include both a battery module 142 and an electrical plug 146 and can supply either battery electricity or grid electricity to the electric motor 140. Some embodiments include multiple battery modules 142. The power source selector 186 is operatively coupled to the controller 162. The power source selector 186 may be any input device capable of switching between a number of different configurations (e.g., a switch, a push button, a knob, etc.). The power source selector 186 allows the user to select between a battery-only configuration, a plugin-only configuration, a boost configuration, and a power combination configuration of the power management system 160. In the battery-only configuration, the power management system 160 provides battery electricity from the battery modules 142 to the electric motor 140. In the plugin-only configuration, the power management system 160 provides grid electricity from the electrical plug 146 to the electric motor 140. In the boost configuration, the power management system 160 provides electrical power from only the battery module 142, but at a higher current than would be possible using grid electricity from the electrical plug 146. In other embodiments, in the boost configuration the power management system 160 provides electrical power from both the battery module 142 and using grid electricity from the electrical plug 146. In some embodiments, grid electricity from the electrical plug 146 is used until maximum allowable current capacity of the circuit breaker (e.g., 15 Amps) is reached. At that point, additional current is drawn from the battery module 142.

In the power combination configuration, the power management system 160 provides battery electricity from the battery modules 142 to the electric motor and provides grid electricity from the electrical plug 146 to the electric motor 140. In the power combination configuration, the electric motor 140 is receiving electricity from both the battery modules 142 and grid electricity simultaneously. Grid electricity is limited by the current capacity of the circuit breaker (typically 15 Amps) to which the pressure washer 100 is connected by the electrical plug 146 (i.e., a grid electricity current), but by routing all of the electricity to the electric motor 140 through the battery module 142, the battery module 142 can provide a current greater (i.e., a battery electricity current) than the grid electricity current (e.g., provide 20 Amps or greater) to the motor 140. A higher current delivered to the motor 140 increases the pressure of the spray from the nozzle 136 and increases flow. In the boost configuration and the power combination configuration, the grid electricity is used to charge the battery module 142 when the pressure washer 100 is not spraying and the electric motor 140 is turned off. This enables the user to use the higher current operation for extended periods of time by automatically recharging the battery module 142 when the electric motor 140 is not in use. In alternative embodiments, dual voltage coils may be used providing more electricity to the electric motor 140 to increase the speed of the electric motor 140 in order to increase water pressure. The user may operate the pressure washer 200 using the dual voltage coils by moving the power source selector 186 to the designated position for the mode utilizing the dual voltage coils.

The configurations provide varying maximum rated water pressures at the outlet 114. The maximum rated water pressure provided by the water pump 110 is the greatest in the power combination configuration. The maximum rated water pressure provided by the water pump 110 is greater in the boost configuration (e.g., 3,000 psi) than in the plugin-only configuration (e.g., 2,000 psi) and in the battery-only configuration (e.g., 1,700 psi). The maximum rated water pressure is greater in the plugin-only configuration than in the battery-only configuration.

In some embodiments, the operating mode is selected by changing the nozzle 136 of the spray gun 130. As such, the power management system 160 selects the power source based on the selection of the nozzle 136. Accordingly, the selection of a particular nozzle 136 can activate a boost configuration in which power is pulled from the battery modules 142. Various nozzles include various effective flow areas (e.g., cross-sectional area or diameter) or restrictions on the flow delivered from the spray gun 130. Based on selection of a nozzle 136 with a relatively low effective flow area (e.g., relatively high restriction of flow), the power management system 160 initiates a boost configuration. For example, the user can select between a first nozzle and a second nozzle. The first nozzle includes an effective flow area greater than the second nozzle. When the user switches out the first nozzle for the second nozzle during operation of the pressure washer 100, the power management system 160 senses the second nozzle (e.g., senses the increased restriction of flow) and activates a boost configuration. In the boost configuration, the system 160 initiates a relatively higher current draw than in the battery-only or plugin-only configurations. As such, the power management system 160 draws power from the battery modules 142 to be provided to the electric motor 140 to increase the pressure of the spray from the nozzle 136. In some embodiments, the power management system 160 senses the increased restriction of flow at the unloading sensor 174 described above. As noted, the unloading sensor 174 is disposed along the path of flow between the outlet 114 and the nozzle 136. In some embodiments, the unloading sensor 174 is a pressure sensor and provides a signal to the controller 162 indicating the pressure of the fluid near the outlet 114. In other embodiments, the unloading sensor 174 is a flow sensor and provides a signal to the controller 162 indicating the flow rate of fluid to the nozzle 136.

Referring to FIG. 6, a schematic diagram showing a boost configuration 500 using the power management system 160 is shown. In some embodiments, the boost configuration 500 utilizes a primary power source 502 (e.g., grid electricity from the electrical plug 146) and a secondary power source 506 (e.g., battery electricity from the battery modules 142) to provide power to the electric motor 140. A charging system 504 is structured to charge the primary power source 502 and the secondary power source 506 during operation of the pressure washer 100. In some embodiment, the power selector 508 shown in FIG. 6 is the power source selector 186 shown in FIG. 2. Accordingly, as noted above, the power selector 508 allows the user to select between a battery-only configuration, a plugin-only configuration, a boost configuration, and a power combination configuration. The power selector 508 is communicably and operatively coupled to the controller 162 of the power management system 160 (shown in FIGS. 1A and 1B) to provide an output 510. The output 510 controls which power source is selected by the controller 162. In the boost configuration 500, the power management system 160 is configured to use grid electricity to charge the battery module 142 when the pressure washer 100 is not spraying and the electric motor 140 is turned off, thereby enabling the user to use the higher current operation for extended periods of time by automatically recharging the battery module 142. In addition, the power management system 160 is configured to use the primary power source 502 (e.g., grid electricity) the charge the secondary power source 504 (e.g., battery module 142) while the electric motor 140 is running. This may be done in both the boost configuration and in the power combination configuration. In this situation, some of the current supplied to the electric motor 140 to increase water pressure is directed to charging the secondary power source 504 (e.g., one or more battery modules 142).

Referring to FIG. 8, a method 700 for charging the secondary power source 504 is shown, according to an exemplary embodiment. The method 700 is performed by the power management system 160 (e.g., controller 162). As such, one or more of the components of FIGS. 1-7 will be referenced in the description of method 700.

The method is initiated at 702. Whether the secondary power source 504 is charged is determined at 704. If the secondary power source 504 is not charged, the primary power source 502 provides charge to the secondary power source 504 and to the electric motor 140 at 706. If the secondary power source 504 is charged or after the secondary power source is charged at 706, the next step is determining whether a boost configuration is selected at 708. The boost configuration is set by a user using the power source selector 186 (or power selector 508). The power source selector 186 communicates the selection to the controller 162. If the user did not select the boost configuration at 708, the controller 162 sets a flag indicating to set no boost parameters at 710. If the user selected the boost configuration at 710, it is determined whether the secondary power source 504 has sufficient allowable energy according to preset parameters at 712. The preset parameters may be set by a manufacturer of the secondary power source 504 or a manufacturer of the pressure washer 100 (e.g., programmed into controller 162). If the secondary power source 504 does not have sufficient allowable energy, the system 160 displays an error message to the user to indicate insufficient charge of the secondary power source 504 at 714. At which point, the system 160 sets a no boost parameter at 710 and controls the primary power source 502 to provide charge to the secondary power source 502 at 706. If the secondary power source 504 has sufficient allowable energy, the system 160 sets boost configuration parameters at 716 and provides charge from the primary power source 502 and the secondary power source 504 at 718. The system 160 routinely checks whether the secondary power source 504 has sufficient charge at 712 and controls the provision of power to and from the primary and secondary power sources 502, 504.

In some embodiments, the power management system 160 includes a circuit or module for measuring a charge of the one or more battery modules 142. The power management system 160 may be configured to automatically switch from the power combination configuration or boost configuration to the plugin-only configuration in response to the charge in the battery module 142 dropping below a threshold level (e.g., 60 volts). In some embodiments, the power management system 160 will default to the battery-only configuration whenever grid electricity is not received from the electrical plug 146. In some embodiments, while in the boost configuration or the plugin-only configuration, the power management system 160 automatically charges the one or more battery modules 142 when the total power draw of the pressure washer 100 drops below a threshold level (e.g., when the electric motor 140 is not running). By way of example, power washer usage typically involves intermittent spraying, so the one or more battery modules 142 are able to charge with grid electricity during pauses in the user's spraying when the electric motor 140 is turned off, thereby extending the operating time of the one or more battery modules 142 and the available time for the user to perform spraying tasks. In some embodiments, the power management system 160 charges the one or more battery modules 142 while the pressure washer 100 is powered off.

In some embodiments, the user interface 180 includes a battery charge indicator 188. The battery charge indicator 188 is operatively coupled to the power management system 160. The battery charge indicator 188 displays one or both of the current charge of the battery modules 142 or an estimated remaining run time to the user. In some embodiments, as shown in FIG. 2, the battery charge indicator 188 is a series of LED's with an included button. When the user presses the button, the LEDs light up, indicating the remaining charge. By way of example, if 60 percent of the charge remained, three of the four lights would be lit, indicating that between 50 percent and 75 percent of the charge remained. In other embodiments, the battery charge indicator 188 may include a display that indicates the percentage charge remaining. In some embodiments, the power management system 160 determines the estimated remaining run time. This determination may take into account the current power configuration (e.g., boost, plugin-only, power combination, or battery-only), the amount of connected battery modules 142, the size of the connected battery modules 142 (e.g., an amp-hour rating), and the use history of the user (e.g., the average power usage of the user), among other factors. The estimated remaining run time may be indicated on a display. In alternative embodiments, the battery charge indicator 188 may be on the battery modules 142 displaying to the user via the LED lights that the battery modules 142 are fully charged or may be partially charged. Indicators, such as LED lights, may also be located on the nozzle, wand or gun portion of the pressure washer 200 to display to the user the charge level of the battery module(s) 142.

A pressure washer 200, shown in FIG. 3, similar to the pressure washer 100 is a floor-standing pressure washer including a base unit and a separate spray gun 230 (discussed below). The base unit includes a support structure 202 to house the internal components of the pressure washer 200, which are similar to the components described in the pressure washer 100 embodiments (e.g., a water pump, an electric motor, a power management system, etc.). In some embodiments, the base unit includes wheels 204 and handles 206 or other components to facilitate transportation of the pressure washer 200. A low-pressure water source 216, which in this embodiment is a municipal water source, is connected to the base unit via inlet fitting 218. An outlet fitting 220 is fluidly coupled to a spray gun 230 by means of high-pressure hose 232. The spray gun 230 includes a trigger 234 that controls the flow of high-pressure water to a nozzle 236 similarly to the pressure washer 100. The trigger 234 may additionally control a valve 238 disposed along a flow path between the outlet fitting 220 and the nozzle 236. Battery electricity can be supplied to the pressure washer 200 by one or more battery modules 242 that are received by one or more receptacles 244. Grid electricity can be supplied to the pressure washer 200 though electrical plug 246 which connects via an electrical extension cord 248 to a standard power outlet 250. The pressure washer 200 includes a GFCI 252 disposed along the outside of the support structure 202 near the electrical plug 246. The pressure washer 200 additionally includes a trigger sensor 276 and a user interface 280 to provide the user more control over the operation of the pressure washer 200. A floor-standing pressure washer like the pressure washer 200 allows the user to use the spray gun 230 without having to support the weight of the base unit.

A pressure washer 300, shown in FIG. 4, similar to the pressure washer 100 is a backpack pressure washer including a base unit and a separate spray gun 330 (discussed below). The base unit includes a support structure 302 to house the internal components of the pressure washer 300, which are similar to the components described in the pressure washer 100 embodiments (e.g., a water pump, an electric motor, a power management system, etc.). The base unit includes a backpack 304 that supports at least a portion of the weight of the base unit and everything attached to the base unit (e.g., one or more battery modules 342, described below) on one or more shoulders of the user. The backpack 304 may incorporate one or more straps 306, as shown in FIG. 4. Pressure washer 300 may additionally include handles 308 or other components to facilitate transportation of the pressure washer 300. A low-pressure water source 316, which in this embodiment is a reservoir coupled to the top of the support structure 302, is fluidly coupled to a water pump (not shown). Alternatively, the water pump may be connected to a water supply by a low-pressure hose. The water pump may be a self-priming water pump to facilitate drawing water from a source with a small head pressure. An outlet fitting 320 is fluidly coupled to a spray gun 330 by means of high-pressure hose 332. The spray gun 330 includes a trigger 334 that controls the flow of high-pressure water to a nozzle 336 similarly to the pressure washer 100. The trigger 334 may additionally control a valve 338 disposed along a flow path between the outlet fitting 320 and the nozzle 336. Battery electricity can be supplied to the pressure washer 300 by one or more battery modules 342 that are received by one or more receptacles 344. Grid electricity can be supplied to the pressure washer 300 though electrical plug 346 which connects via an electrical extension cord 348 to a standard power outlet 350. The pressure washer 300 includes a GFCI 352 disposed along the outside of the support structure 302 near the electrical plug 346. The pressure washer 300 additionally includes a trigger sensor 376 and a user interface 380 to provide the user with more control over the operation of the pressure washer 300. A backpack pressure washer like the pressure washer 300 allows the user to carry the base unit on their back or shoulders instead of rolling the base unit along the ground, which may be advantageous in areas with uneven terrain (e.g., on a ladder). In some embodiments, the pressure washer 300 can be converted to a floor-standing pressure washer (e.g., by removing the backpack 304 and adding wheels). The pressure washer 300 is similar in size and use to a backpack leaf blower.

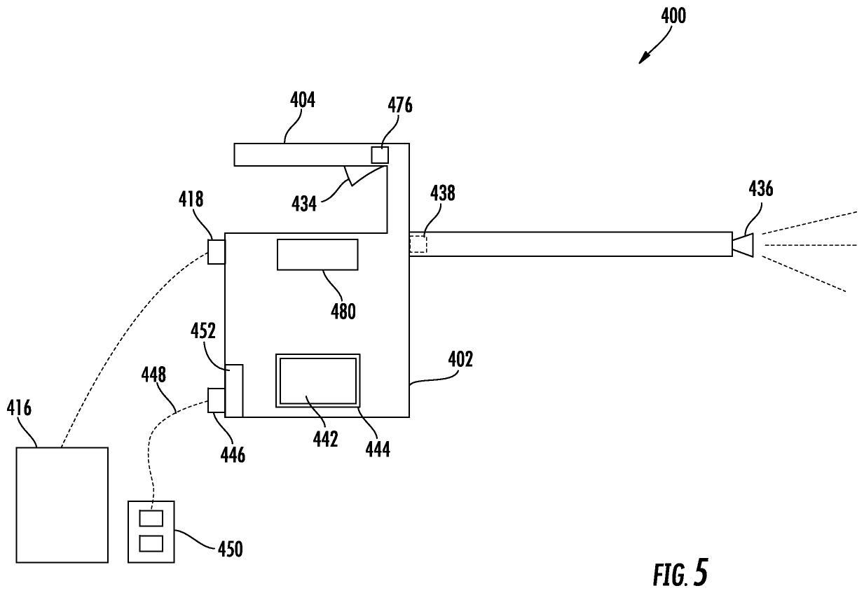

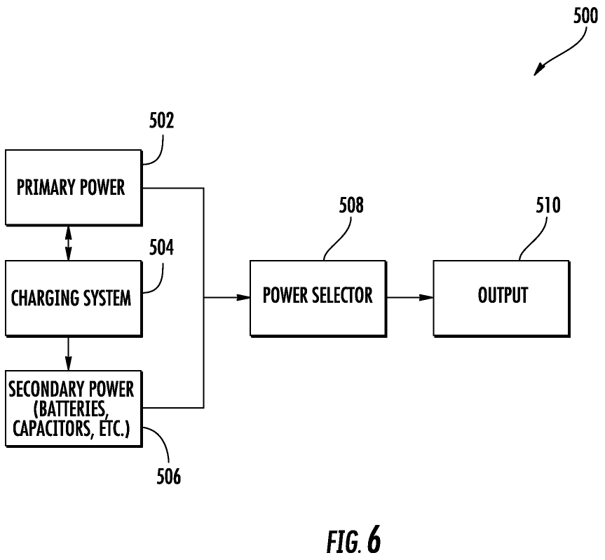

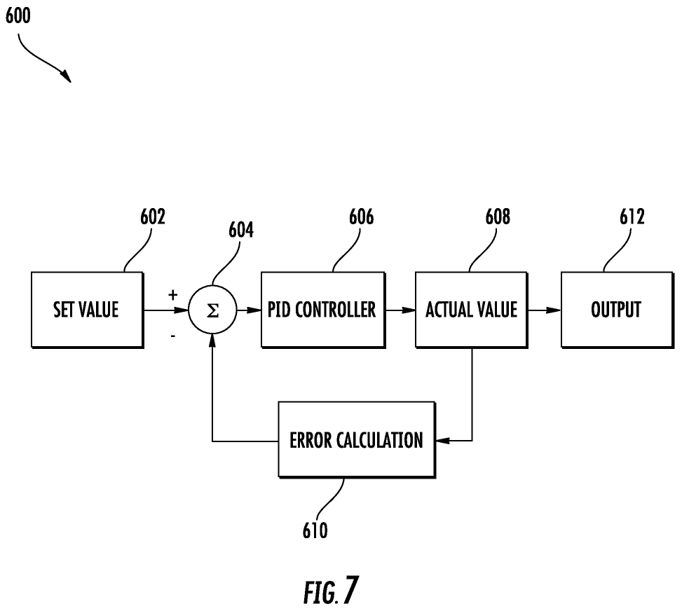

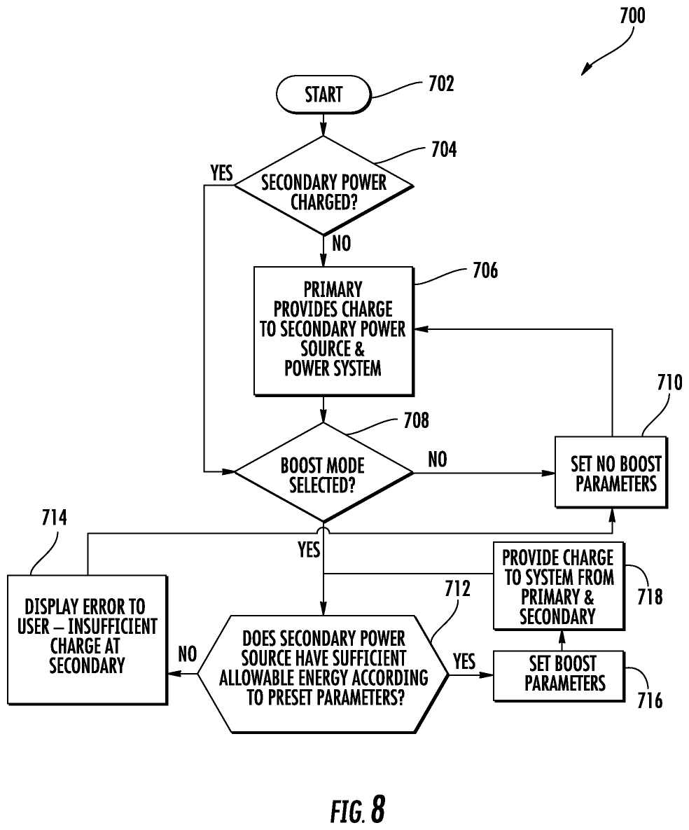

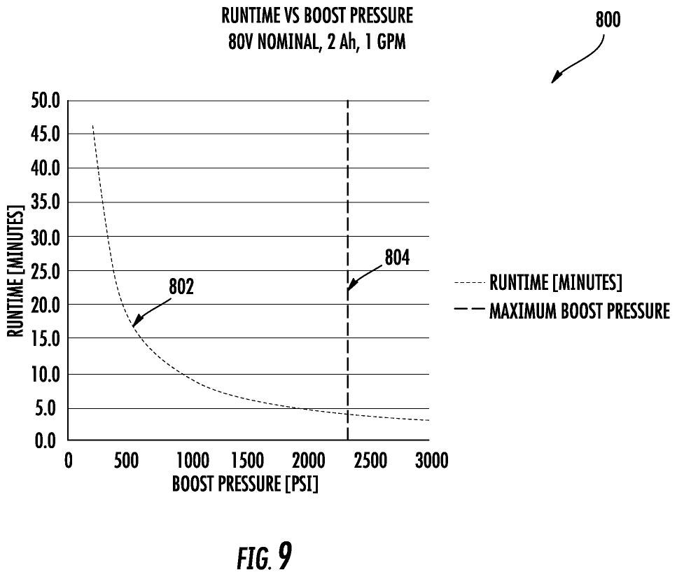

A pressure washer 400, shown in FIG. 5, similar to the pressure washer 100 is a handheld pressure washer includes a spray gun unit without a separate spray gun. The spray gun unit includes a support structure 402 to house the internal components of the pressure washer 400, which are similar to the components described in the pressure washer 100 embodiments (e.g., a water pump, an electric motor, a power management system, etc.). The internal components and a nozzle 436 (described below) are components of the spray gun unit, such that low-pressure fluid enters the spray gun unit and high-pressure fluid is ejected from the spray gun unit through the nozzle 436. The pressure washer 400 may incorporate a handle 404, straps, or other components to facilitate transportation of the pressure washer 400. A low-pressure water source 416, which in this embodiment is a municipal water source, is connected to the base unit via inlet fitting 418. A trigger 434 is connected to the handle 404 and controls the flow of high-pressure water to nozzle 436 similarly to the pressure washer 100. The trigger 434 may additionally control a valve 438 disposed along a flow path between the inlet fitting 418 and the nozzle 436. Battery electricity can be supplied to the pressure washer 400 by one or more battery modules 442 that are received by one or more receptacles 444. Grid electricity can be supplied to the pressure washer 400 though electrical plug 446 which connects via an electrical extension cord 448 to a standard power outlet 450. The pressure washer 400 includes a GFCI 452 disposed along the outside of the support structure 402 near the electrical plug 446. The pressure washer 400 additionally includes a trigger sensor 476 and a user interface 480 to provide the user more control over the operation of the pressure washer 200. A handheld pressure washer like the pressure washer 400 allows the user to carry only a single spray gun unit instead of a base unit and a separate spray gun, which facilitates maneuvering with the pressure washer 400. The pressure washer 400 is similar in size and use to a handheld leaf blower.

The construction and arrangement of the apparatus, systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, some elements shown as integrally formed may be constructed from multiple parts or elements, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

1. A pressure washer, comprising:
a water pump;
a spray gun fluidly coupled to an outlet of the water pump;
an electric motor coupled to the water pump to drive the water pump;
a battery module configured to provide battery electricity;
an electrical plug configured to receive grid electricity from a power outlet; and
a power management system electrically connected to the battery module, the electrical plug, and the electric motor, the power management system configured to selectively provide battery electricity from the battery module and grid electricity from the electrical plug to the electric motor to drive the water pump.

2. The pressure washer of claim 1, wherein in a battery-only configuration, the power management system provides battery electricity from the battery module to the electric motor, and wherein in a plugin-only configuration, the power management system provides grid electricity from the electrical plug to the electric motor.

3. The pressure washer of claim 2, wherein in a boost configuration, the power management system provides electrical power from the battery module at a battery electricity current greater than a grid electricity current available via the electrical plug and from the electrical plug to the electric motor.

4. The pressure washer of claim 2, wherein in a boost configuration, if the grid electricity reaches a maximum allowable capacity, the power management system provides additional electrical power from the battery module.

5. The pressure washer of claim 3, wherein a maximum rated water pressure provided by the water pump is greater in the boost configuration than in the plugin-only configuration and in the battery-only configuration.

6. The pressure washer of claim 5, wherein the power management system is configured to measure a charge of the battery module and wherein the power management system is configured to switch from the boost configuration to the plugin-only configuration in response to the charge dropping below a threshold level.

7. The pressure washer of claim 5, further comprising a user interface operably coupled to the power management system, wherein the power management system is configured to switch between the battery-only configuration, the plugin-only configuration, and the boost configuration in response to a user input received by the user interface.

8. The pressure washer of claim 3, wherein the spray gun further comprises a plurality of nozzles to vary the effective flow area, each nozzle having a different effective flow area;
wherein a first nozzle of the plurality of nozzles has a first effective flow area and a second nozzle of the plurality of nozzles has a second effective flow area, the first effective flow area greater than the second effective flow area;
wherein upon sensing the second nozzle, the power management system is configured to switch to the boost configuration.

9. The pressure washer of claim 5, further comprising a base unit and a ground fault circuit interrupter unit electrically connected between the electrical plug and the power management system, wherein the base unit is configured to support the water pump, the electric motor, and the battery module, wherein the ground fault circuit interrupter unit is configured to selectively electrically disconnect the power management system from the grid electricity upon detection of a ground fault, and wherein the ground fault circuit interrupter unit is located at least partially within the base unit.

10. The pressure washer of claim 1, wherein the spray gun includes a trigger configured to control a flow rate of water through the spray gun;
wherein the pressure washer further comprises a trigger sensor operably coupled to the power management system and configured to sense a position of the trigger, wherein the power management system is configured to vary a speed of the electric motor in response to a sensed position of the trigger and thereby vary a water pressure of a spray provided by the spray gun.

11-12. (canceled)

13. The pressure washer of claim 1, further comprising a user interface operably coupled to the power management system, wherein the power management system is configured to vary a speed of the electric motor in response to an input received by the user interface.

14. The pressure washer of claim 1, further comprising an unloading sensor fluidly coupled to the outlet of the water pump and operatively coupled to the power management system, wherein the power management system is configured to stop the electric motor in response to a signal from the unloading sensor.

15. The pressure washer of claim 1, further comprising a receptacle configured to receive battery electricity from the battery module, wherein the receptacle is electrically connected to the power management system, wherein the receptacle receives the battery module, and wherein the battery module is removable from the receptacle without the use of tools.

16-17. (canceled)

18. A backpack pressure washer, comprising:
a water pump;
an electric motor coupled to the water pump to drive the water pump;
a spray gun fluidly coupled to an outlet of the water pump;
a battery module configured to selectively provide battery electricity to the electric motor;
a backpack supporting the water pump, the electric motor, and the battery module, wherein the backpack is configured to support a portion of a weight of the backpack pressure washer on at least one shoulder of a user.

19. The backpack pressure washer of claim 18, further comprising a reservoir configured to contain a volume of liquid and fluidly coupled to an inlet of the water pump, wherein the reservoir is supported by the backpack.

20. The backpack pressure washer of claim 18, wherein the backpack includes a strap configured to support the portion of the weight of the backpack pressure washer on the at least one shoulder of the user.

21. The backpack pressure washer of claim 18, further comprising a receptacle configured to receive battery electricity from the battery module, wherein the receptacle provides battery electricity to the electric motor, wherein the receptacle receives the battery module, and wherein the battery module is removable from the receptacle without the use of tools.

22. A pressure washer, comprising:
a water pump;
an electric motor coupled to the water pump to drive the water pump;
at least two battery modules configured to provide battery electricity; and
a power management system electrically connected to the at least two battery modules and configured to selectively provide battery electricity from the battery modules to the electric motor.

23. The pressure washer of claim 22, further comprising a user interface operatively coupled to the power management system, wherein the power management system selects between a series connection and a parallel connection between the at least two battery modules in response to a signal from the user interface.

24. The pressure washer of claim 23, further comprising at least one receptacle configured to receive battery power from the at least two battery modules, wherein the at least one receptacle is electrically connected to the power management system, wherein the at least one receptacle receives the at least two battery modules, and wherein the at least two battery modules are removable from the at least one receptacle without the use of tools.
